(19) United States
(12) Patent Application Publication
(10) Pub. No.: US 2022/0356371 A1
(43) Pub. Date: Nov. 10, 2022

(54) RUBBERIZED ASPHALT COATINGS FOR BALLASTED TRACK AND RELATED SYSTEMS AND METHODS

(71) Applicant: TRAMMCO, LLC, Suffolk, VA (US)

(72) Inventors: William H. Moorhead, JR., Suffolk, VA (US); Jerry G. Rose, Lexington, KY (US)

(21) Appl. No.: 17/730,270

(22) Filed: Apr. 27, 2022

Related U.S. Application Data
(60) Provisional application No. 63/186,483, filed on May 10, 2021.
(60) Provisional application No. 63/295,985, filed on Jan. 3, 2022.

(51) Int. Cl. C09D 195/00; E01B 3/10; E01B 3/36

(52) U.S. Cl. CPC C09D 195/00; E01B 3/10; E01B 3/36; E01B 1/001

(57) ABSTRACT

An example method for forming a track system includes: providing track ties configured to support rails; providing stone ballast configured to support the track ties; and disposing a layer of rubberized asphalt coating between the ballast and the track ties, the rubberized asphalt coating having a bituminous binder, crumb rubber particles, and small gradation stone aggregate; wherein resiliency of the layer of rubberized asphalt coating permits particles of the ballast in direct contact with the layer of rubberized asphalt coating to move elastically relative to the bottom of the tie and to each other while inhibiting abrasion of adjacent ones of the particles of the ballast against each other and against the bottom of the track ties.

### CROSS REFERENCE TO RELATED APPLICATIONS

This utility patent application claims the benefit of and priority to U.S. Provisional Application 63/186,483, filed on May 10, 2021, and U.S. Provisional Application 63/295,985, filed on Jan. 3, 2022, the entirety of each of which is incorporated herein by reference.

### BACKGROUND

### Field of the Disclosure

The present disclosure generally related to transportation systems and, more specifically, to ballasted track systems as well as related materials, components and methods.

### Description of the Related Art

Since the introduction of concrete crossties after World War II, their application has been plagued by interface issues between the hard bottom of the tie and the supporting stone ballast bed. The issues are the result of two hard surfaces coming into repeated contact under high unit pressures generated by the high axle loads typical of North American railroading and heavy-haul railroads all over the world. Because ballasted track with concrete ties has a high track modulus (usually >6 ksi), the load distribution tends to be less than that in wood tie track, so it is safe to assume that the tie directly under an axle supports 50% of the axle load, or approximately 39 kips max (without impact). A German scientist years ago postulated that with sharply angular prismatic ballast stone, only 2% of the tie bottom area was in contact with supporting ballast stones. For a typical North American concrete tie, the bottom area is 10.3″×102″=1050.6 in², but only about 75% of that area (i.e., the portions centered under the rails) is in actual bearing resulting in an effective bearing area of approximately 790 in². Assuming the German scientist was too cautious, we'll assume a 3% effective contact area, which results in a unit pressure on the ballast stones of 1,640 psi. This may not be exact but is borne out by lab experiments and field measurements. That is, over an order of magnitude greater than the typical calculations for the bearing loads on the ballast bed when using the Talbot formulae and accounts for the destruction of the ballast stone particles by impact, cleavage and wear, which reduces the nominal ballast gradation size rather quickly under heavy tonnage, generating fines and causing drainage issues at the same time. As the stone particles become less angular from these causes, there is a greater tendency for the ballast to “churn”, causing faster degradation. All this results in ballast fouling, differential track subsidence, short ballast life, and higher maintenance costs.

It should be mentioned that train-generated high-frequency vibrations are also a contributing factor, possibly substantial, to ballast degradation. Train-generated high-frequency vibrations have been studied in France and Germany, where high-speed trains are common, but not much data has been obtained on this side of the Atlantic.

In Europe, the problem was addressed by Under Tie Pads (UTP—in Europe, Under Sleeper Pads—USP). A UTP is a pad that covers most of the tie bottom, especially the most heavily loaded portions, that is made from and by a variety of materials and methods, including recycled tire rubber in a polymeric binder, and plastics including polyethylene, polyvinyl, EPDM, polyurethane, etc. They come in different thicknesses, with 10-12 mm (0.394-0.472-in) being common types and are attached to the concrete ties in various ways, including adhesives, a special “furry” surface or protruding “knob” shapes on the UTP's that bond with the molten concrete when applied at the concrete tie mill.

Generally, all the UTP's commercially available perform the functions intended: 1) lower the track modulus; 2) reduce ballast degradation; and 3) reduce the required track maintenance. We use fairly “soft” pads in North America, usually in the 65-80 Shore A (durometer) range. Conversely, in Europe, a very high percentage of the USP's are quite “hard”, in the Shore D 70-90 range (about as hard as a bowling ball), which probably is driven by two (2) factors: 1) cost; and 2) lighter axle loads. The static bedding modulus of these pads is typically in the 740−<920 lbf/in³ (0.20-0.25 N/mm³) range. It has been shown that the thickness of the UTP may be the most important factor in how well it performs—the thicker, the better.

UTP's are generally well-accepted by the concrete tie-using North American railroads, used primarily on ballast-deck bridges and other trouble spots such as high-tonnage special trackwork and tunnels, for example. A primary reason that there is not much higher usage is the high cost; installing a UTP increases the cost of a concrete tie at the mill by 25% to 40%, depending on the type UTP used. This is too big a premium to pay to use along entire lengths of rail, so the user railroads only tend to use UTP's in trouble spots.

The following is presented to address one or more of the aforementioned, and potentially other, perceived shortcomings of the prior art.

### SUMMARY

An example embodiment of a method for forming a track system having rails comprises: providing a plurality of track ties configured to support the rails; providing stone ballast configured to support the plurality of track ties; and disposing a layer of rubberized asphalt coating between the ballast and the plurality of track ties, the rubberized asphalt coating having a bituminous binder, crumb rubber particles, and small-gradation stone aggregate; wherein resiliency of the layer of rubberized asphalt coating permits particles of the ballast in direct contact with the layer of rubberized asphalt coating to move elastically relative to each other while inhibiting abrasion of adjacent ones of the particles of the ballast against each other and against the bottom of the track ties.

In some embodiments, the rubberized asphalt coating exhibits 6% to 10% by volume of the bituminous binder, 22% to 40% by volume of the crumb rubber particles, and 58% to 72% by volume of the small gradation stone aggregate;

In some embodiments, the layer of rubberized asphalt coating further comprises polymer modifiers of the bituminous binder configured to increase adhesion to the stone aggregate and enhance plasticity for reducing cracking.

In some embodiments, the layer of rubberized asphalt coating exhibits 5% to 8% by volume of air voids.

In some embodiments, disposing the layer of rubberized asphalt coating between the ballast and the plurality of track ties comprises: forming pads that incorporate the layer of rubberized asphalt coating; and attaching the pads to the plurality of track ties.

In some embodiments, disposing the layer of rubberized asphalt coating between the ballast and the plurality of track ties comprises applying the layer of rubberized asphalt coating to respective undersides of the plurality of track ties.

In some embodiments, applying the layer of rubberized asphalt coating comprises adhering the layer of rubberized asphalt coating to the respective undersides of the plurality of track ties without using an additional adhesive.

In some embodiments, applying the layer of rubberized asphalt coating comprises compacting the layer of rubberized asphalt coating against the respective undersides of the plurality of track ties.

In some embodiments, compacting the layer of rubberized asphalt coating comprises forming indentations in an exterior surface of the layer of rubberized asphalt coating.

In some embodiments, the rubberized asphalt coating is configured as a cold-mix formulation that does not require heating.

In some embodiments, the rubberized asphalt coating is configured as a formulation that requires heating.

In some embodiments, the crumb rubber particles comprise recycled vulcanized rubber.

An example embodiment of track system comprises: a pair of rails; a plurality of track ties configured to support the pair of rails; ballast configured to support the plurality of track ties; and a layer of rubberized asphalt coating disposed as an interface between the ballast and the plurality of track ties, the rubberized asphalt coating having bituminous binder, crumb rubber particles, and small-gradation stone aggregate; wherein resiliency of the layer of rubberized asphalt coating permits particles of the ballast in direct contact with the layer of rubberized asphalt coating to move elastically relative to each other while inhibiting abrasion of adjacent ones of the particles of the ballast against each other.

In some embodiments, the rubberized asphalt coating exhibits 6% to 10% by volume of the bituminous binder, 22% to 40% by volume of the crumb rubber particles, and 58% to 72% by volume of the small gradation stone aggregate

In some embodiments, the plurality of track ties comprises wooden track ties.

In some embodiments, the plurality of track ties comprises concrete track ties.

In some embodiments, the plurality of track ties comprises composite track ties.

In some embodiments, the plurality of track ties comprises steel track ties.

In some embodiments, the layer of rubberized asphalt coating is configured as a plurality of pads, with each of the plurality of ties having a corresponding one of the plurality of pads attached thereto.

In some embodiments, each of the plurality of pads has a substrate in direct contact with a corresponding portion of the layer of rubberized asphalt coating.

In some embodiments, each of the plurality of ties has multiple ones of the plurality of pads attached thereto.

An example embodiment of a material for use in a track system having rails, a supporting structure configured to support the rails, and ballast configured to support the supporting structure, comprises: a rubberized asphalt coating configured to form a contiguous, resilient interface between the ballast and the supporting structure, the rubberized asphalt coating having a polymer-modified bituminous binder, crumb rubber particles, and small-gradation stone aggregate; wherein resiliency of the rubberized asphalt coating permits particles of the ballast in direct contact with the rubberized asphalt coating to move elastically relative to each other while inhibiting abrasion of adjacent ones of the particles of the ballast against each other and against the supporting structure.

In some embodiments, the rubberized asphalt coating exhibits 6% to 10% by volume of the bituminous binder, 22% to 40% by volume of the crumb rubber particles, and 58% to 72% by volume of the small gradation stone aggregate.

An example embodiment of a tie for forming a track system having rails, comprises: an elongate body having an underside; and a compacted layer of rubberized asphalt coating adhered to the underside, the rubberized asphalt coating having a bituminous binder, crumb rubber particles, and stone aggregate.

In some embodiments, the rubberized asphalt coating exhibits 6% to 10% by volume of the bituminous binder, 22% to 40% by volume of the crumb rubber particles, and 58% to 72% by volume of the stone aggregate.

In some embodiments, an exterior surface of the layer of rubberized asphalt coating exhibits indentations formed into the exterior surface.

In some embodiments, the stone aggregate is small gradation stone aggregate with a top size of not greater than ⅜ inch and a bottom size of no less than 1/16 inch.

An example embodiment of a method for forming a track system having rails, comprises: providing a layer of rubberized asphalt coating having a bituminous binder, crumb rubber particles, and small gradation stone aggregate, the rubberized asphalt coating exhibiting 6% to 10% by volume of the bituminous binder, 22% to 40% by volume of the crumb rubber particles, and 58% to 72% by volume of the small gradation select stone aggregate; disposing ballast, configured to support the plurality of track ties, on the layer of rubberized asphalt coating; and disposing a plurality of track ties, configured to support the rails, on the ballast; wherein resiliency of the layer of rubberized asphalt coating permits particles of the ballast in direct contact with the layer of rubberized asphalt coating to move elastically relative to each other while inhibiting abrasion of adjacent ones of the particles of the ballast against each other.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flowchart of an example embodiment of a method for forming a track system.

FIG. 2 is a cut-away, cross-sectional, schematic view of an example embodiment of a rubberized asphalt coating.

FIG. 3 is a schematic view of an example embodiment of a track tie and an associated layer of rubberized asphalt coating.

FIG. 4 is a schematic view of an example embodiment of a track system.

FIG. 5 is a schematic, cross-sectional view of the embodiment of FIG. 4 as viewed along section line 5-5.

FIG. 6 is a schematic view of another example embodiment of a track tie and an associated layer of rubberized asphalt coating.

FIG. 7 is a schematic view of another example embodiment of a layer of rubberized asphalt coating.

FIG. 8 is a schematic view of another example embodiment of a track system.

FIG. 9 is a schematic, enlarged view of a portion of the embodiment of FIG. 8.

### DETAILED DESCRIPTION

Reference will now be made in detail to the description of the disclosure as illustrated in the drawings. While the disclosure will be described in connection with these drawings, there is no intent to limit it to the embodiment or embodiments disclosed herein.

As will be described, embodiments may provide more protection and lateral resistance than elastomeric pads or ballast mats used with track systems and may reduce the breakage and wear of the ballast directly under the tie, as well as reduce the track modulus (such as by approximately 30% or more), thereby providing a smoother, less damaging ride. In some embodiments, this may be achieved by disposing a rubberized asphalt coating incorporating a bituminous binder, crumb rubber particles, and stone aggregate between the ballast and the load-bearing surfaces of the track ties. The rubberized asphalt coating inhibits abrasion of adjacent ones of the particles of the ballast against each other and against the bottom of the track ties.

Movement of the ballast particles and the fact that the bituminous binder (asphalt) is viscoelastic allows asperities on the angular ballast to penetrate and “key” into the layer. This may accomplish one or more of the following in some embodiments: 1) preventing the ballast particles from coming into direct, impactful contact with the bottom of the ties, reducing cleavage, rounding, and generation of fines; 2) increasing the effective bearing area of the ballast particles (e.g., a sharp ballast particle can have the bearing area increased by over 1,700% with a penetration into the layer of only ⅜-inch, reducing the contact pressure to under 100 psi from the 1,640 psi); and 3) reducing the propensity for the ballast particles to roll and churn, thus reducing inter-particle abrasion and impact damage.

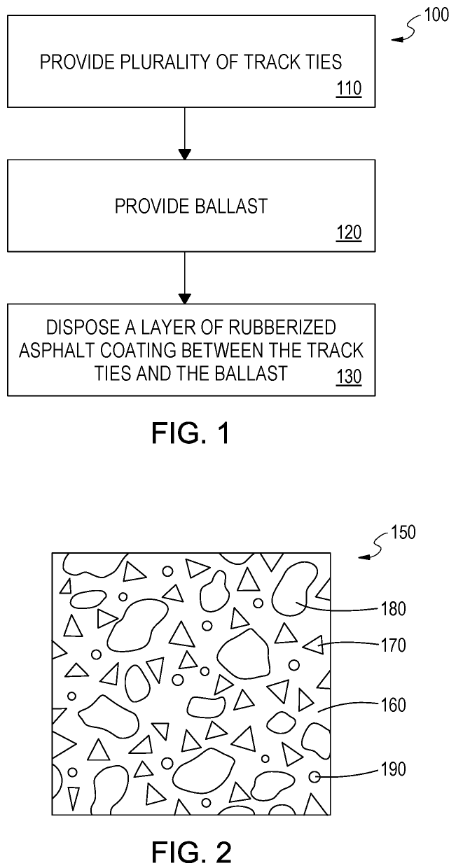

An example embodiment of a method for forming a track system is depicted in FIG. 1. As shown in FIG. 1, method 100 may be construed as beginning at block 110 of the flowchart, in which a plurality of track ties configured to support rails is provided. In block 120, ballast configured to support the plurality of track ties is provided. Then, as depicted in block 130, a layer of rubberized asphalt coating is disposed between the ballast and the plurality of track ties. In some embodiments, the layer of rubberized asphalt coating is adhered to respective undersides of the plurality of track ties. This may involve compacting the layer of rubberized asphalt coating against the track ties. In some embodiments, the layer of rubberized asphalt coating is provided in the form of pads that incorporate the layer of rubberized asphalt coating. The pad(s) are then attached to the track ties.

Resiliency of the layer of rubberized asphalt coating permits particles of the ballast in direct contact with the layer of rubberized asphalt coating to move elastically relative to each other while inhibiting abrasion of adjacent ones of the particles of the ballast against each other and against the bottom of the track ties.

As shown in the schematic diagram of FIG. 2, rubberized asphalt coating 150 incorporates a bituminous binder 160, crumb rubber particles 170, and stone aggregate 180. In some embodiments, the rubberized asphalt coating may exhibit 6% to 10% by volume of the bituminous binder, 22% to 40% by volume of the crumb rubber particles, and 58% to 72% by volume of the stone aggregate. The constituent components are mixed to ensure dispersal throughout the coating as layering of the components within the coating is not desired.

The bituminous binder is formed primarily and, in some applications, exclusively of bitumen. In some embodiments, one or more polymer modifiers are added to the bituminous binder to increase adhesion to the stone aggregate and enhance plasticity for reducing/preventing cracking. Selection of a suitable polymer modifier may be based on one or more additional factors, such as whether the rubberized asphalt coating is configured as a cold-mix formulation that does not require heating or as a formulation that requires heating (e.g., warm-mix or hot-mix).

The crumb rubber particles may be formed of and/or include recycled vulcanized rubber, in some embodiments, such as tire-derived aggregate. In some embodiments, the crumb rubber particles are medium-gradation particles (i.e., generally ⅛″ to 5/16″ in nominal size). The volume of crumb rubber particles used may vary depending upon the application to accommodate a full range of axle loads and ballast types. By way of example, for rail transit with relatively low axle loads, the percentage can be quite high (>40%), which provides a much lower Bedding Modulus to provide a quieter ride and reduce both ground-borne vibration and air-borne noise issues.

The stone aggregate generally consists of hard stone; however, in some embodiments, soft stone (e.g., limestone) may be used in addition to or as an alternative to hard stone. Although various gradations of stone may be used depending upon the application, some embodiments may use small gradation stone aggregate (i.e., stone aggregate with the top size not to exceed ⅜″ (9.5 mm) and the bottom size not to be less than 1/16″ (1.59 mm). Selection of the gradation of stone aggregate may be performed by screen filtering, with 100% passing a #4 screen and 100% being retained on a #30 screen, for example. In some embodiments, all of the stone aggregate in a rubber asphalt coating (with the exception of minor amounts of other gradations) may be small gradation stone aggregate.

The rubberized asphalt coating may also exhibit air voids (e.g., air void 190), such as 5% to 8% by volume of air voids in some embodiments.

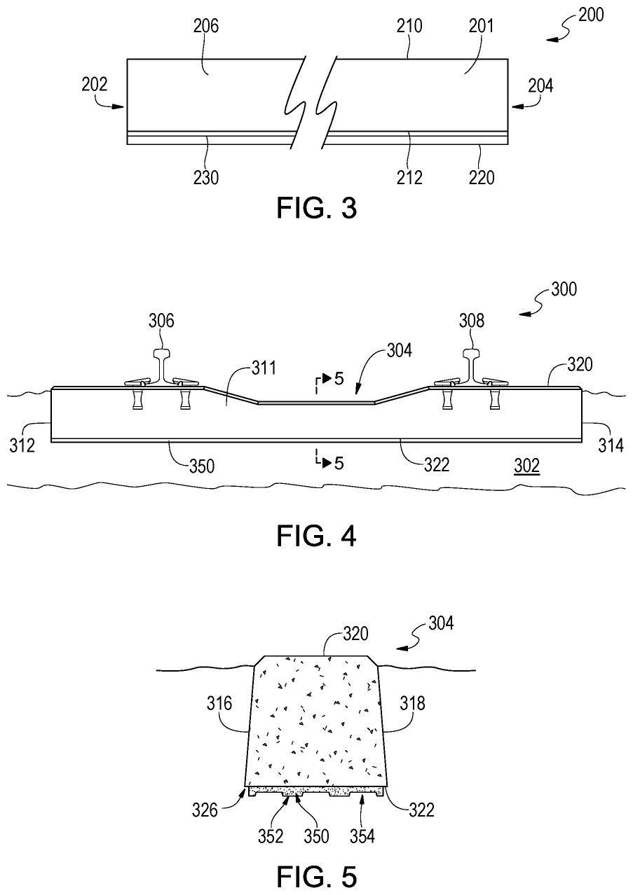

As shown in FIG. 3, an example embodiment of track tie 200 includes an elongate body 201 with ends 202, 204, and opposing sides (only one of which, 206, is shown) that extend lengthwise between the ends. Track tie 200 also exhibits a topside 210, which is configured to support rails, and an underside 212. Elongate body 201 may be formed of one or more of various materials, such as, but not limited to, concrete, wood, steel and composite.

A layer of rubberized asphalt coating 220 is adhered to underside 212. Rubberized asphalt coating 220 can be installed during manufacture of the tie, for example, or in the field. Typically, field installation may require an adhesive to bond the rubberized asphalt coating 220 to the tie. In this embodiment, adhesion of rubberized asphalt coating 220 to elongate body 201 is facilitated by a layer of adhesive 230, which may be formed of epoxy or epoxy-modified asphalt. It should be noted that, in some embodiments, adequate adhesion may be obtained without the use of a layer of adhesive, in which case the rubberized asphalt coating directly contacts the underside of the track tie. Compacting of the layer of rubberized asphalt coating to a desired degree (e.g., at least 95% Proctor) may facilitate this adhesion.

Several methods for applying rubberized asphalt coatings to ties may be used: 1) a hot-mix application (350°-400° F. temperature range); 2) a warm-mix application (250°-300° F. temperature range); 3) a cold-mix application (room temperature), such as by using an emulsified asphalt binder; and 4) an adhesive retention application such as by using pre-formed layers (e.g., pads).

Rubberized asphalt coating tends to be viscous enough that forming is not required during application and, as such, may be applied by techniques similar to those used in asphalt paving. In some embodiments (such as in small lot applications), rubberized asphalt coating may be applied by hand in a manner similar to putting mortar on blocks; that is, by using hand trowels and compacting the rubberized asphalt coating with a compactor (e.g., a vibratory plate compactor). Notably, a compactor may have asperities to create a “dimpled” pattern in the exterior surface of the rubberized asphalt coating that may increase lateral and longitudinal resistance to movement in the ballast bed. The incorporation of asperities (e.g., surface roughness and/or indentations) may be an optional feature in all embodiments.

In some embodiments (such as in long-line tie mill applications), rubberized asphalt coating may be placed using a spreader (e.g., a purpose-designed carrier-spreader that runs on rails used for the wire-stretching and concrete placement). The carrier-spreader deposits the rubberized asphalt coating on the bottoms of the still-molten ties and a compactor (e.g., a roller compactor) consolidates the rubberized asphalt coating and adjusts the final thickness. The ties are then cured and demolded per usual practice.

In some embodiments (such as in carousel-type tie-production applications), there may be a fixed station added that deposits the rubberized asphalt coating on the bottoms of the still-molten ties and a compactor (e.g., a vibratory plate compactor) to consolidate the rubberized asphalt coating and adjust the final thickness. Once again, the ties are then cured and demolded per usual practice.

In some embodiments (such as when ties are located at the user's storage facility), the ties may be oriented upside down and arranged on supports (e.g., in a rank-and-file pattern) to form a “road” of ties. For instance, the pattern may be at least 6-feet wide and at least 100-feet long. A driveway-sized power-screed paver of suitable width then may be driven over the tie “road” depositing and compacting the rubberized asphalt coating to the proper thickness. This may be followed by a compactor (e.g., a small vibratory roller compactor) to consolidate the rubberized asphalt coating and finish the application. The ties are then separated, turned upright, and returned to storage or loaded for transport for installation.

Alternatively, in some embodiments, conveyor system may be used to move the ties under a delivery hopper-screed fixture that will apply the rubberized asphalt coating to the tie bottoms and then move the coated ties under a fixture (e.g., a vibratory roller fixture) that will consolidate and finish the rubberized asphalt coating.

In some embodiments, rubberized asphalt coating may be provided in pad configuration that is attached to a tie. By way of example, such a pad may be bonded to the molten concrete of a concrete tie during manufacture. In other applications, such a pad may be attached to a tie by an adhesive layer and/or mechanical fasteners.

Thickness of a layer of rubberized asphalt coating may vary depending upon the application. By way of example, a nominal ⅝-inch layer may be used in some embodiments, whereas, in others, a thicker layer (e.g., 1-inch) may be used to provide more cushioning and vibration reduction. Thickness of a layer of rubberized asphalt coating may additionally or alternatively be based on one or more factors, such as the gradation of ballast to be used to support the track and the typical facet angularity of that ballast. In some embodiments, the rubberized asphalt coating will be in the range of ½″ to 1″ thick.

As shown in FIGS. 4 and 5, an example embodiment of a track system 300 incorporates ballast 302 that is used to support track ties, only one of which (track tie 304) is depicted. The track ties are spaced along the lengths of a pair of rails 306, 308, which are shown in cross-sectional end view. Track tie 304 includes an elongate body 311 with ends 312, 314, and opposing sides 316, 318 that extend lengthwise between the ends, as well as a topside 320 and an underside 322. A compacted layer of rubberized asphalt coating 350 is disposed along underside 322. In some embodiments, layer 350 (which may be formed as a contiguous composition or by pre-formed pads) covers an entirety of underside 322. Rubberized asphalt coating 350 may cover less than the entire underside 322. Notably, approximately 97% coverage is provided in the embodiment of FIG. 5, with rubberized asphalt coating 350 being absent from a periphery region 326. Various degrees of coverage may be used depending upon the application, such as those that exhibit material discontinuities along the length and/or width of a tie. For instance, adjacent sections of rubberized asphalt coating may be separated from each other.

As shown in FIG. 5, the exterior surface 352 of the layer of rubberized asphalt coating 350 may exhibit indentations (that is, depressions deeper than surface texture attributable to the material constituents of the rubberized asphalt coating). An indentation (e.g., indentation 354), which may be formed in the layer during manufacturing, for example, may be configured to promote “keying” of ballast particles into the layer of rubberized asphalt coating 350 when the track tie is installed. It should also be noted that ties formed of materials other than concrete (e.g., wood, steel and composite) may be used.

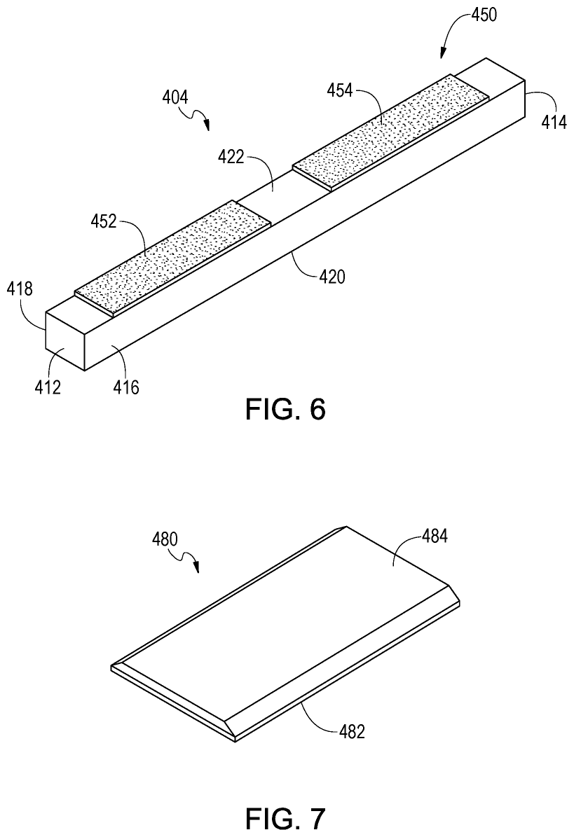

Another example embodiment of a track tie is depicted in FIG. 6, with the tie being shown in an inverted orientation. In FIG. 6, track tie 404 includes an elongate body 411 with ends 412, 414, and opposing sides 416, 418 that extend lengthwise between the ends, as well as a topside 420 and an underside 422. A layer of rubberized asphalt coating 450, which is configured as pre-formed pads, is disposed along underside 422. In this embodiment, two such pads (452, 454) are used although various other numbers (e.g., 1, 3, 4, etc.) may be used depending upon the application. Various degrees of coverage of underside 422 by one or more pads also may be used depending upon the application. In this example, pads 452 and 454 are separated from each other, as well as from ends 412 and 414, respectively. In some embodiments, at least 75% of the underside of a tie is covered by rubberized asphalt coating 450, with the pad(s) generally being centered under the expected load areas of the tie (e.g., under the rail seats).

Another example embodiment of a pad will be described with respect to FIGS. 7-9. As shown in FIG. 7, pad 480 includes a substrate 482 and a rubberized asphalt coating 484. In some embodiments, substrate 482 may be formed of a fibrous material (e.g., a geotextile and/or fiberglass). Pads such as pad 480 may be manufactured by a continuous extrusion process in which rubberized asphalt coating is deposited onto material forming the substrate, and then cut into desired lengths. In some embodiments, rubberized asphalt coating 484 is self-adhering to substrate 482; however, attachment between these constituents may be facilitated by another material, such as an adhesive, for example.

Typically, pad 480 is attached to a tie so that substrate 482 faces towards the corresponding tie and rubberized asphalt coating 484 faces away from the tie. In some embodiments, substrate 482 may be configured to penetrate and bond with the material forming the tie, such as molten concrete. In other embodiments, an adhesive layer and/or mechanical fasteners may be used to facilitate attachment of the pad to a tie.

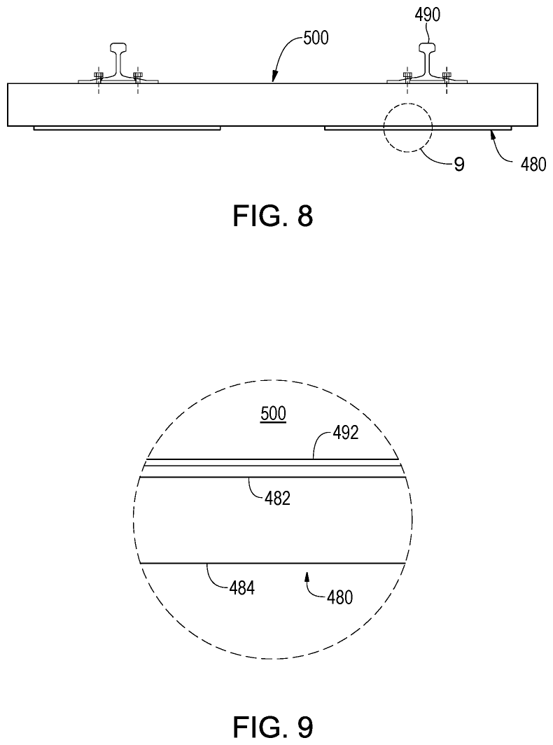

An example application that uses pad 480 is shown in FIG. 8. Note that pad 480 is generally centered under rail 490 and its anticipated load. In FIG. 9, an adhesive layer 492 is disposed between pad 480 and the underside of tie 500 to facilitate attachment.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure.

What is claimed is:

1. A method for forming a track system having rails, the method comprising:
providing a plurality of track ties configured to support the rails;
providing stone ballast configured to support the plurality of track ties; and
disposing a layer of rubberized asphalt coating between the ballast and the plurality of track ties, the rubberized asphalt coating having a bituminous binder, crumb rubber particles, and small gradation stone aggregate, the rubberized asphalt coating exhibiting 6% to 10% by volume of the bituminous binder, 22% to 40% by volume of the crumb rubber particles, and 58% to 72% by volume of the small gradation stone aggregate;
wherein resiliency of the layer of rubberized asphalt coating permits particles of the ballast in direct contact with the layer of rubberized asphalt coating to move elastically relative to the bottom of the tie and also to each other while inhibiting abrasion of adjacent ones of the particles of the ballast against each other and against the bottom of the track ties.

2. The method of claim 1, wherein the layer of rubberized asphalt coating further comprises polymer modifiers of the bituminous binder configured to increase adhesion to the stone aggregate and enhance plasticity for reducing cracking.

3. The method of claim 1, wherein the layer of rubberized asphalt coating exhibits 5% to 8% by volume of air voids.

4. The method of claim 1, wherein disposing the layer of rubberized asphalt coating between the ballast and the plurality of track ties comprises applying the layer of rubberized asphalt coating to respective undersides of the plurality of track ties.

5. The method of claim 4, wherein applying the layer of rubberized asphalt coating comprises adhering the layer of rubberized asphalt coating to the respective undersides of the plurality of track ties without using an additional adhesive.

6. The method of claim 4, wherein applying the layer of rubberized asphalt coating comprises compacting the layer of rubberized asphalt coating against the respective undersides of the plurality of track ties.

7. The method of claim 6, wherein compacting the layer of rubberized asphalt coating comprises forming indentations in an exterior surface of the layer of rubberized asphalt coating.

8. The method of claim 1, wherein disposing the layer of rubberized asphalt coating between the ballast and the plurality of track ties comprises:
forming pads that incorporate the layer of rubberized asphalt coating; and
attaching the pads to the plurality of track ties.

9. The method of claim 1, wherein the rubberized asphalt coating is configured as a cold-mix formulation that does not require heating.

10. The method of claim 1, wherein the rubberized asphalt coating is configured as a formulation that requires heating.

11. The method of claim 1, wherein the crumb rubber particles comprise recycled vulcanized rubber.

12. A track system comprising:
a pair of rails;
a plurality of track ties configured to support the pair of rails;
ballast configured to support the plurality of track ties; and
a layer of rubberized asphalt coating disposed as an interface between the ballast and the plurality of track ties, the rubberized asphalt coating having bituminous binder, crumb rubber particles, and small gradation stone aggregate, the rubberized asphalt coating exhibiting 6% to 10% by volume of the bituminous binder, 22% to 40% by volume of the crumb rubber particles, and 58% to 72% by volume of the small gradation stone aggregate;
wherein resiliency of the layer of rubberized asphalt coating permits particles of the ballast in direct contact with the layer of rubberized asphalt coating to move elastically relative to the bottom of the tie and to each other while inhibiting abrasion of adjacent ones of the particles of the ballast against each other.

13. The track system of claim 12, wherein the plurality of track ties comprises wooden track ties.

14. The track system of claim 13, wherein the layer of rubberized asphalt coating is configured as a plurality of pads, with each of the plurality of ties having a corresponding one of the plurality of pads attached thereto.

15. The track system of claim 14, wherein each of the plurality of pads has a substrate in direct contact with a corresponding portion of the layer of rubberized asphalt coating.

16. The track system of claim 13, wherein each of the plurality of ties has multiple ones of the plurality of pads attached thereto.

17. A tie for forming a track system having rails, comprising:
an elongate body having an underside; and
a compacted layer of rubberized asphalt coating adhered to the underside, the rubberized asphalt coating having a bituminous binder, crumb rubber particles, and stone aggregate, the rubberized asphalt coating exhibiting 6% to 10% by volume of the bituminous binder, 22% to 40% by volume of the crumb rubber particles, and 58% to 72% by volume of the stone aggregate.

18. The tie of claim 17, wherein the elongate body is formed of concrete.

19. The tie of claim 17, wherein an exterior surface of the layer of rubberized asphalt coating exhibits indentations formed into the exterior surface.

20. The tie of claim 17, wherein the stone aggregate is small gradation stone aggregate with a top size of not greater than ⅜ inch and a bottom size of no less than 1/16 inch.
